(19) United States
(12) Patent Application Publication
(10) Pub. No.: US 2018/0119241 A1
(43) Pub. Date: May 3, 2018

(54) Severe Plastic Deformation of Iron-Cobalt-Vanadium Alloys

(71) Applicants: Ibrahim Karaman, (US); Taymaz Jozaghi, (US); National Technology & Engineering Solutions of Sandia, LLC, Albuquerque, NM (US)

(72) Inventors: Donald F. Susan, Albuquerque, NM (US); Jeffrey Rodelas, Albuquerque, NM (US); Blythe Clark, Albuquerque, NM (US); Ibrahim Karaman, College Station, TX (US); Taymaz Jozaghi, College Station, TX (US)

(21) Appl. No.: 15/797,260

(22) Filed: Oct. 30, 2017

Related U.S. Application Data
(60) Provisional application No. 62/415,936, filed on Nov. 1, 2016.

(51) Int. Cl. C21D 8/12; C22C 38/10; C22C 38/12; C22C 30/00; H01F 1/147

(52) U.S. Cl. CPC C21D 8/1216; C22C 38/10; H01F 1/147; C22C 30/00; C22C 38/12

(57) ABSTRACT

Severe mechanical deformation in addition to thermal processing can be used to produce microstructural refinement in iron-cobalt-vanadium alloys. As an example, significant grain refinement through Equal Channel Angular Extrusion (ECAE), also known as Equal Channel Angular Pressing (ECAP), at high temperatures was demonstrated in bulk Hiperco soft magnetic alloy. The ECAE material exhibited high strength levels comparable to Hiperco sheet and the ductility was higher than heat treated conventional bar with large grain size. The increase in ductility was attributed to small grain size and the disordered phase that may co-exist with the ordered phase. In addition, the ECAP material also displays good magnetic properties, with relatively high magnetic saturation as shown in the B-H curve. The heat treatment after ECAP improves magnetic performance, with some tradeoff in mechanical properties. Therefore, with proper choice of post-ECAP heat treatment, an optimum combination of mechanical and magnetic performance can be achieved for a desired application, such as in solenoid switches, electric motors, and generators.

### CROSS-REFERENCE TO RELATED APPLICATION

This application claims the benefit of U.S. Provisional Application No. 62/415,936, filed Nov. 1, 2016, which is incorporated herein by reference.

### STATEMENT OF GOVERNMENT INTEREST

This invention was made with Government support under Contract No. DE-NA0003525 awarded by the United States Department of Energy/National Nuclear Security Administration. The Government has certain rights in the invention.

### FIELD OF THE INVENTION

The present invention relates to magnetic metal alloys and, in particular, to the severe plastic deformation of iron-cobalt-vanadium (Fe-Co-V) alloys to produce deformed alloys with simultaneously good magnetic and mechanical properties.

### BACKGROUND OF THE INVENTION

In most materials, a dramatic increase in strength would also come with a concomitant decrease in ductility. However, it has been shown that high amounts of cold-work, as obtained in sheet product, can actually improve the strength and ductility of Hiperco® (Hiperco is an iron-cobalt-vanadium soft magnetic alloy. Hiperco® is a registered trademark of Carpenter Technology Corporation, Reading, Pa.). See M. R. Pinnel and J. E. Bennett, Met. Trans. 5, 1273 (1974); K. Kawahara, J. Mater. Sci. 18, 3437 (1983); K. Kawahara, J. Mater. Sci. 18, 3427 (1983); K. Kawahara, J. Mater. Sci. 18, 2047 (1983); and K. Kawahara, J. Mater. Sci. 18, 1709 (1983). However, Hiperco in bar form has low mechanical strength and is well-known to exhibit low tensile elongation (low ductility) and undergo brittle fracture at room temperature. See T. Sourmail, Prog. Mater. Sci. 50, 816 (2005). On the other hand, Hiperco has the highest saturation magnetization of any commercial alloy, with high magnetic permeability and low coercivity, all hallmarks of good soft magnetic behavior. Therefore, it is used in applications such as solenoids, electric motors, and generators that take advantage of its excellent magnetic behavior. However, the poor mechanical properties of Hiperco limit its application in high performance components that may encounter mechanical stresses due to shock, vibration, etc.

Therefore, a need remains for Fe-Co-V alloys in bulk form that simultaneously have good magnetic and mechanical properties, with both high strength and ductility.

### SUMMARY OF THE INVENTION

The present invention is directed to a method to produce soft magnetic alloys with good mechanical properties, comprising providing a bar of a Fe-Co-V alloy; heating the bar to greater than 650° C. to increase ductility; and subjecting the heated bar to severe plastic deformation, thereby producing a deformed alloy having a very fine grain size and a uniform grain size from center to edge of the bar. The invention can further comprise heat treating the deformed alloy to optimize the tradeoff between mechanical properties and magnetic behavior.

As an example of the invention, the soft magnetic alloy Hiperco 50A (49Fe-49Co-2V) was subjected to Equal Channel Angular Extrusion (ECAE), a severe plastic deformation (SPD) process. Microstructural characterization showed that ECAE dramatically refined the grain size (1-3 micron range) compared to conventional Hiperco bar (>25 microns). The mechanical properties of ECAE Hiperco are far superior to conventional bar. Yield strengths of 650-700 MPa (94-102 ksi) and ultimate tensile strengths of 900-1400 MPa (130-200 ksi) were achieved, representing a 2- to 3-fold increase in strength compared to conventional bar. Importantly, the ductility of Hiperco was also improved by ECAE, with 15-20% elongation for optimized ECAE samples compared to 4-7% elongation for conventional bar material. After ECAE, samples were heat treated at 838° C. for 2 hours followed by cooling at ˜120° C./hr in order to increase magnetic performance. The heat treatment improved the magnetic response significantly compared to the as-extruded condition, with magnetic saturation and permeability comparable to Hiperco sheet and conventional bar material. In addition, upon heat treatment of the ECAE Hiperco alloy, even lower coercivity was obtained. The coercivity of heat treated ECAE Hiperco bar was 0.30 Oersteds compared to about 2.3 Oersteds for conventional bar material. However, both strength and ductility were reduced after heat treatment. The ECAE process parameters and post-ECAE heat treatment can be adjusted to find the best combination of mechanical properties and magnetic performance for a given application.

### BRIEF DESCRIPTION OF THE DRAWINGS

The detailed description will refer to the following drawings, wherein like elements are referred to by like numbers.

FIG. 1 is a schematic illustration of the Equal Channel Angular Extrusion (ECAE) process.

FIG. 2 is a graph of the elevated temperature mechanical properties (hot ductility) of Hiperco obtained with a thermomechanical simulator.

FIG. 3 is a schematic illustration showing the extrusion plane, flow plane, extrusion direction, and flow direction of an extruded bar.

FIGS. 4A-4D are backscatter scanning electron micrographs (SEMs) of ECAE sample 6E. FIGS. 4A and 4B show the microstructure in the extrusion plane (EP). FIGS. 4C and 4D show the microstructure in the flow plane (FP).

FIG. 5 is a graph of the stress-strain curves from ECAE samples 6E, 4C, and 4C-AQ in the as-ECAE condition in the extrusion direction (ED) and flow direction (FD) tensile test orientations. Results are also shown for conventional bar heat treated at 680, 840, and 865° C.

FIG. 6 is a graph showing the Hall-Petch grain size dependence of yield strength for FeCo-based alloy bar, ECAE Hiperco bar, and cold-worked sheet.

FIG. 7 is a graph of full B-H hysteresis curves for as-ECAE Hiperco and heat treated ECAE Hiperco compared to Hiperco sheet specimens.

FIG. 8B is a graph of B-H hysteresis curves for as-ECAE Hiperco and heat treated ECAE Hiperco compared to a conventional heat-treated Hiperco bar.

FIG. 8A is an expanded B-H hysteresis curve with y-axis limits of 0 to 3 Tesla and x-axis limits of −10 to +10 Oersteds.

FIG. 9 is a graph of B-H hysteresis curves of ECAE Hiperco bar along with conventional Hiperco bar in the mill-run condition and four different heat treat conditions.

FIG. 10 is a graph of magnetic B-H curves of Hiperco bar materials along with alternative alloys Fe-3% Si and Chrome-Core (low S).

### DETAILED DESCRIPTION OF THE INVENTION

The present invention uses severe plastic deformation (SPD) in addition to thermal processing to produce microstructural refinement in Fe—Co—V alloys, thereby producing metals that simultaneously have good magnetic and mechanical properties in bulk (bar) form. SPD includes a group of metalworking techniques involving very large plastic strains typically involving a complex stress state or high shear, resulting in a deformed metal with a very fine grain size. SPD techniques include Equal Channel Angular Extrusion (ECAE, also known as Equal Channel Angular Pressing, or ECAP), accumulated roll bonding (ARB), high pressure torsion (HPT), mechanical alloying (MA), etc. See https://en.wikipedia.org/wiki/Severe_plastic_deformation, downloaded from the Internet, Sept. 9, 2016; and A. Azushima et al., CIRP Annals—Manufacturing Technology 57(2), 716 (2008), both of which are incorporated herein by reference. As used herein, a bar or billet refers to a solid piece of metal that has not been rolled into a sheet or formed into a structural shape, such as an angle, channel, tube, or pipe. The most common shapes for a bar include a round bar or rod, a rectangular or square bar, and a hexagonal bar or hex bar.

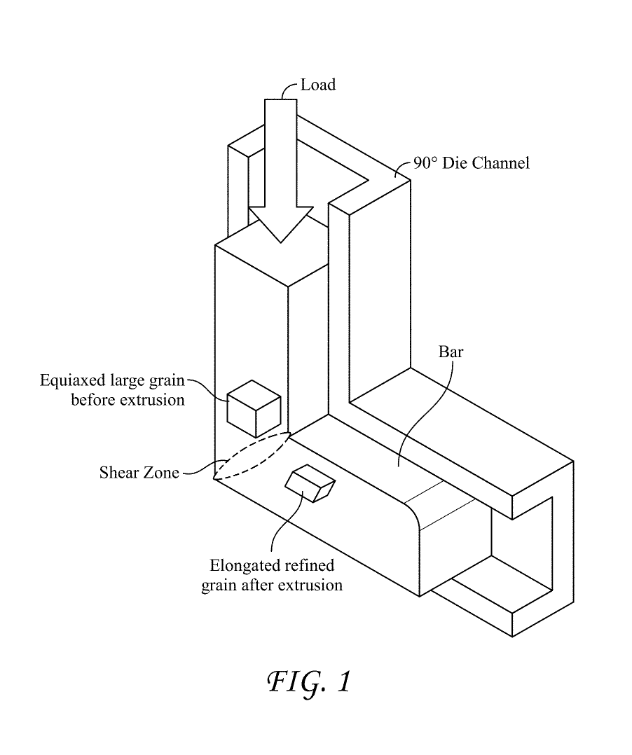

In particular, ECAE can be used to achieve severe plastic deformation. In ECAE, a bar of material is extruded through a die with an abrupt corner, usually with a 90° angle, as shown in FIG. 1. High amounts of shear deformation, >100% effective strain, are produced within the bar as it progresses through the angled region but the overall dimensions of the bar do not change (the strain depends on the die angle. For a 90° die angle, the strain is 1.15, or 115% per pass). Depending on the homologous temperature of the SPD process, dynamic recrystallization takes place resulting in a very fine grain size. The grain refinement is responsible for the dramatic increases in yield and tensile strength observed with SPD processes, such as ECAE. The bar can be passed through the ECAE die multiple times to further increase strain and grain refinement.

According to ASTM A801, the standard specification for wrought iron-cobalt high magnetic saturation alloys is 47.50 to 49.50 wt % cobalt, 1.75 to 2.10 wt % vanadium, with balance iron. As an example of the present invention, ECAE was used to achieve beneficial effects on both strength and ductility in Hiperco 50A, a soft magnetic alloy with nominal composition 49 wt % iron, 49 wt % cobalt, and 2 wt % vanadium. ECAE offers the promise of producing “sheet-like microstructure and properties in bar”. The higher strength of sheet is obtained through grain refinement, i.e. the well-known Hall-Petch effect, wherein yield strength increases as the grain size decreases. See T. Sourmail, Prog. Mater. Sci. 50, 2005, 816 (2005); C. H. Shang et al., J. Mater. Res. 15(4), 835 (2000); B. Nabi et al., Mater. Sci. Eng. A A592, 70 (2014); B. Nabi et al., Mater. Sci. Eng, A A578, 215 (2013); L. Ren et al., J. Mater. Sci. 36, 1451 (2001); R. H. Yu et al., J. Appl. Phys. 85(9), 6655 (1999); K. R. Jordan and N. S. Stoloff, Trans. Metall. Soc. AIME 245, 2027 (1969); D. F. Susan et al., “Hall-Petch Behavior of Fe—Co—V Soft Magnetic Alloy Barstock”, presented at Materials Science & Technology 2014, Pittsburgh, Pa., October 2014; Lie Zhao and I. Baker, Acta Metall. Mater. 42(6), 1953 (1994); E. P. George et al., Mater. Sci. Eng. A A329-331, 325 (2002); A. Duckham et al., Acta Mater. 51, 4083 (2003); and R. T. Fingers et al., J. Appl. Phys. 91(10), 7848 (2002). The improved ductility of sheet could be due to an increase in the disordered bcc phase after rolling as opposed to the more brittle ordered B2 structure. But even with post-rolling heat treatment to induce ordering, relatively high ductility can be retained. The reason(s) for improved ductility in sheet material are not well understood, but could involve the following: 1) the formation of local concentration-disordered (LCD) zones as proposed by Kawahara, or 2) second phase particles, very fine grain size, or partial recrystallization with subgrains acting to prevent dislocation pileups and crack propagation, i.e. “slip partitioning” or “slip dispersion.” See K. Kawahara, J. Mater. Sci. 18, 3437 (1983); K. Kawahara, J. Mater. Sci. 18, 3427 (1983); K. Kawahara, J. Mater. Sci. 18, 2047 (1983); K. Kawahara, J. Mater. Sci. 18, 1709 (1983); E. P. George et al., Mater. Sci. Eng. A A329-331, 325 (2002); N. S. Stoloff et al., Ordered Alloys: Structural Applications and Physical Metallurgy, Claitors, Baton Rouge, Fla., 1970, p. 525; N. S. Stoloff and R. G. Davies, Acta Metall. 12, 473 (1964); N. S. Stoloff and R. G. Davies, Prog. Mater. Sci., 3 (1966); C. D. Pitt and R. D. Rawlings, Metal Sci. 17, 261 (1983); and D. R. Thornburg, J Appl. Phys. 40(3), 1579 (1969). Note these explanations are separate from the theories put forth to account for the ductility from vanadium additions in Fe—Co—V compared to (very brittle) binary Fe—Co. See R. S. Sundar and S. C. Deevi, Intermetallics 12, 921 (2004).

In addition to mechanical properties, the magnetic performance of Hiperco must also be considered when assessing the effects of thermomechanical processing. Well-annealed, soft Hiperco with large grain size and fully-ordered B2 (L2₀) crystal structure displays the best soft magnetic behavior because there is little impedance to magnetic domain wall movement. Unfortunately, this annealed Hiperco material is both mechanically weak and brittle. Conversely, in materials with fine grain size and/or high levels of cold work (resulting in internal stress and/or elevated dislocation density), domain wall movement is restricted and coercivity increases and permeability generally decreases. See C. M. Orrock, Ph.D. thesis, London University, 1986; E. Hug et al., J. Magn. Magn. Mater. 215-216, 197 (2000); and N. Volbers and J. Gerster, “High Saturation, High Strength Iron-Cobalt Alloy for Electrical Machines”, Proceedings of the INDUCTICA, CWIEME, Berlin 2012.

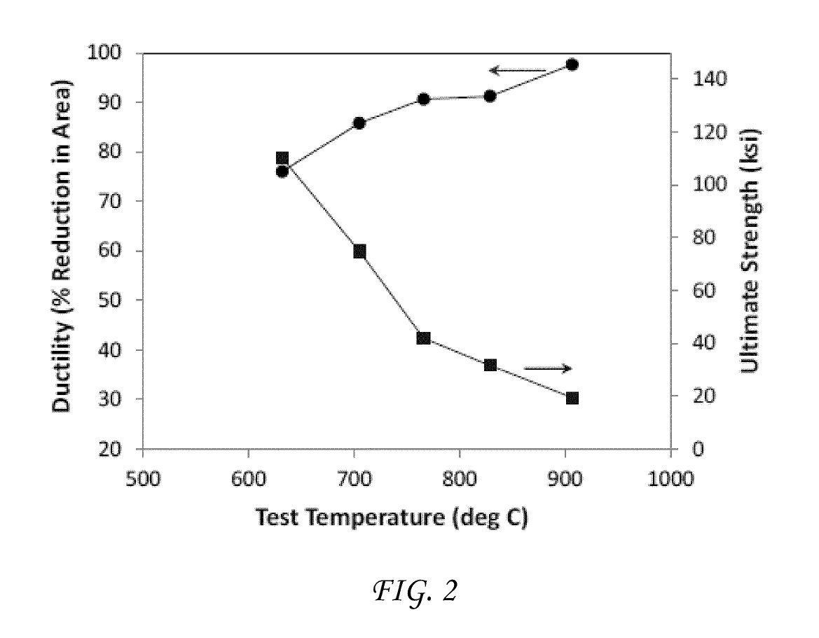

As mentioned above, Hiperco is relatively brittle at room temperature and would not normally be considered a good candidate for an extrusion process. However, since ECAE can be performed at elevated temperatures, the high-temperature ductility of Hiperco is sufficient to survive the ECAE process without catastrophic failure. Therefore, prior to beginning any ECAE trials, the hot ductility of Hiperco was investigated using a thermomechanical simulator. The thermomechanical simulator employs resistive heating to generate high temperatures within a sample while simultaneously applying tensile or compressive forces. Hot ductility tensile tests were performed between 650 and 900° C., as shown in FIG. 2. Hiperco samples display substantial necking prior to failure with reduction in area>75% and increasing with test temperature above 650° C. In particular, Hiperco has appreciable ductility at high temperatures. This behavior is in contrast to the brittle nature of Hiperco near room temperature where little reduction in area and no necking are observed prior to failure. These hot ductility results indicate that Hiperco can withstand severe plastic deformation at high temperatures.

Equal Channel Angular Extrusion of Hiperco

The ECAE process is usually performed with multiple passes, as shown in Table 1. In between each pass, the extruded bar is axially rotated either 90 or 180 degrees, which is simplified by the use of square sections. The various ECAE routes are known as A, B, C, C′, and E. The ECAE route refers to the sequence of axial rotations applied in between each ECAE extrusion pass. In the present examples, the ECAE die used was a patented design with moving sidewalls before the extrusion angle and a moveable base after the extrusion angle in order to reduce friction. See V. M. Segal et al., U.S. Pat. No. 5,400,633 (1995). Square bars allow for flat moveable die channels with simple design. Other details of the ECAE process are given elsewhere. See V. M. Segal, Mat. Sci. Eng. A A386, 269 (2004), which is incorporated herein by reference.

Routes C and E were utilized as examples of the invention, as shown in Table 2. ECAE bars with a 25.4 mm by 25.4 mm square cross section and 150 mm long were prepared from Hiperco with composition: 49.1 wt.% Co, 1.93 wt.% V, 0.051 wt.% Nb and balance Fe. Prior to heating, high temperature lubricant was applied and bars were held in a furnace at the specified temperature for 30 minutes, while the die was held at a constant 350° C., thus the extrusions were carried out non-isothermally. The extrusion rate was 12.7 mm/sec. Bars were slightly milled between each pass to create flat and level surfaces. Sample 4E was processed with four passes at 850° C. following Route E. Sample 6E began with four passes at 850° C. following Route E (i.e., 4E) followed by two passes (i.e., 5&6E) at 750° C. in order to further refine the microstructure. Sample 4C started with two passes of Route C (i.e., 2C) at 850° C. followed by two passes (i.e., 3&4C) at 750° C. in order to produce similar microstructural refinement with fewer passes. Sample 4C-AQ began with two passes of Route C (i.e., 2C), followed by two passes (i.e., 3&4C) at 750° C. All bars were water quenched immediately after extrusion, except for 4C-AQ which was air cooled after the final extrusion pass.

The reason for the selection of routes C and E was to obtain near-equiaxed grains and weak crystallographic texture such that texture-induced magnetic anisotropy would not be developed, since these routes are known to produce the weakest texture among most known ECAE routes. Based on the hot ductility results, an initial extrusion temperature of 850° C. was chosen. Successful ECAE results were achieved with four passes of Route E at 850° C., sample 4E. The intent was to keep the temperature as low as possible to attain the greatest microstructural refinement, i.e. limit grain growth during extrusion. Initial passes at 750° C. or 700° C. were unsuccessful presumably due to the formation of the brittle ordered B2 phase; the order/disorder temperature is approximately 720° C. in the Fe—Co system. See T. Nishizawa and K. Ishida, 2nd Ed. Binary Alloy Phase Diagrams, Vol. 2, ASM International, Materials Park, Ohio, (1990). However, a few passes at 850° C. allowed for subsequent finishing passes at 750° C. as shown in Table 2, suggesting improved ductility from SPD from the initial passes. Finally, sample 4C-AQ was a repeat of 4C except after the last pass the sample was air cooled. Slow cooling, e.g. 120° C./hr, was typically used to obtain good magnetic properties.

TABLE 1
ECAE process routes showing the number of passes, the rotation
between each pass, and the general effects on the sample microstructure.

| | Min. # | Bar rotations about the | | | | Mate- | Effect on |
|---|---|---|---|---|---|---|---|
| Route | of | extrusion axis | | | | rial | micro- |
| name | passes | 1 -> | 2 -> | 3 -> | 4 -> N | Yield | structure |
| A | 1 | 0° | 0° | 0° | etc. | 0.58 | elongation |
| | | | | | | | (lamellar) |
| B (B_{A}) | 2 | +90° | −90° | +90° | etc. | 0.67 | elongation |
| | | | | | | | (filamentary) |
| C | 2 | 180° | 180° | 180° | etc. | 0.83 | back/forth |
| | | | | | | | shearing |
| C′ (Bc) | 4 | +90° | +90° | +90° | etc. | 0.67 | back/forth |
| | | | | | | | cross- |
| | | | | | | | shearing |
| E | 4 | 180° | 90° | 180° | etc. | 0.78 | back/forth |
| | | | | | | | cross- |
| | | | | | | | shearing |

TABLE 2
ECAE samples produced.

| Sample | ECAC Route |
|---|---|
| 4E | 4E-850° C.-0.5 hr-0.5″/sec (WQ) |
| 6E | 4E-850° C.-0.5 hr-0.5″/sec |
| | 5&6E-750° C.-0.5 hr-0.5″/sec (WQ) |
| 4C | 2C-850° C.-0.5 hr-0.5″/sec |
| | 3&4C-750° C.-0.5 hr-0.5″/sec (WQ) |
| 4C-AQ | 2C-850° C.-0.5 hr-0.5″/sec |
| | 3&4C-750° C.-0.5 hr-0.5″/sec (AQ) |

Microstructural Characterization of ECAE Hiperco

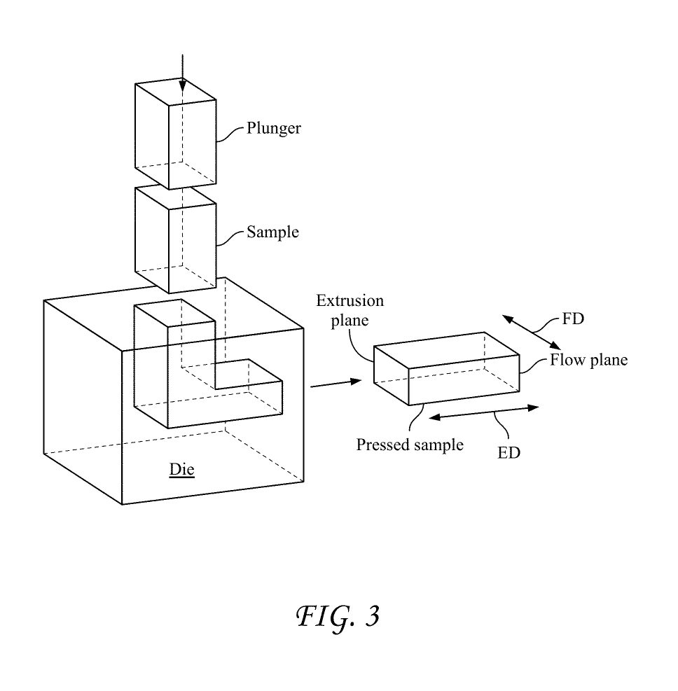

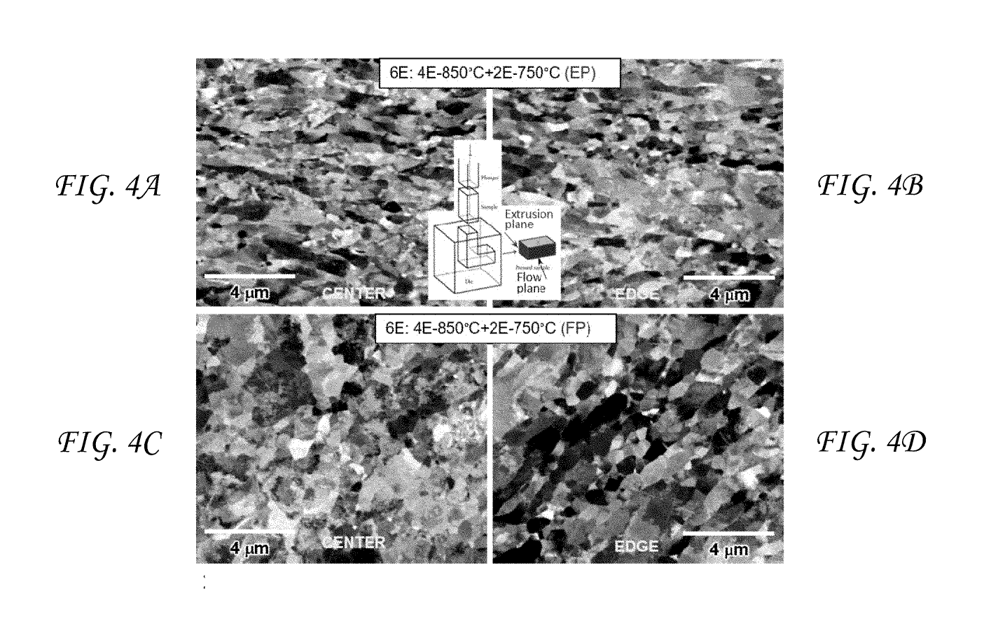

As shown in FIG. 3, samples for microscopy were cut in Extrusion Plane (EP) and Flow Plane (FP) orientations, at least 3 mm away from the surface, and polished to 0.06 micron colloidal silica. Microstructural characterization was performed using a scanning electron microscope (SEM) with 25 kV accelerating voltage. Backscattered scanning electron (BSE) micrographs of sample 6E are shown in FIGS. 4A-4D to illustrate the fine grain size obtained with ECAE. Grain size of 1.5 to 3 microns was estimated based on BSE channeling contrast. No significant differences were observed between the microstructure near the center of the extrusion and that near the outside edge. It is clear that significant grain refinement occurs during ECAE, even at 850° C., which is about 0.64×Tₘ homologous temperature for Hiperco. The two extra route C passes and the lower finishing temperature do not appear to significantly alter the microstructure compared to sample 4E (not shown), which was processed at 850° C. only. The fine grain size indicates that dynamic recrystallization occurs during ECAE at these temperatures without extensive grain growth, which is likely limited due to the short duration of extrusion. In addition, with 500 ppm Nb added to this lot of Hiperco, the formation of NbC precipitates could pin grain boundaries to maintain a fine grain size during ECAE, similar to the effect of Nb additions (3000 ppm) in Hiperco 50HS sheet. See Carpenter Technology Technical Data Sheet Hiperco 50A Alloy, (2008), cartech.ides.com/datasheet; and R. T. Fingers et al., J. Appl. Phys. 91, 7848 (2002). Furthermore, a subgrain structure might exist, with low angle grain boundaries, which could be an important factor for ductility and may not be apparent in SEM/BSE images. Grain refinement and partial recovery can lead to increases in both strength and ductility as shown in a few recent ECAE studies, such as for a Nb-1% Zr alloy. See T. Niendorf et al., Acta Mat. 55, 6596 (2007). For comparison to fine grain size obtained in sample 6E, conventional Hiperco bar exhibits grain sizes in the range of ˜20-75 microns, depending on the heat treat temperature. See K. R. Jordan and N. S. Stoloff, Trans. Metall. Soc. AIME 245, 2027 (1969); D. F., presented at Mat. Sci. Tech. 2014, Pittsburgh, Pa., (2014); and Lie Zhao and I. Baker, Acta Met. Mat. 42, 1953 (1994). Conventional bar is typically used in the heat-treated condition. However, as-received bar possesses a grain structure on a similar scale resulting in similar yield strength. Also, conventional bar, unlike ECAE material, typically exhibits a grain size gradient, with larger grains near the bar exterior and finer grains near the center. See D. F., presented at Mat. Sci. Tech. 2014, Pittsburgh, Pa., (2014). Post-ECAE annealing, which may be performed to induce ordering and increase magnetic performance, will likely result in coarsening of the ECAE microstructure. Nevertheless, significant heat-treat processing space (intermediate times, temperatures) is available between the as-ECAE structure and fully annealed microstructure to improve magnetic performance without excessive grain growth, thereby maintaining a high strength level.

Tensile Testing of ECAE Hiperco Bar and Conventional Hiperco Bar

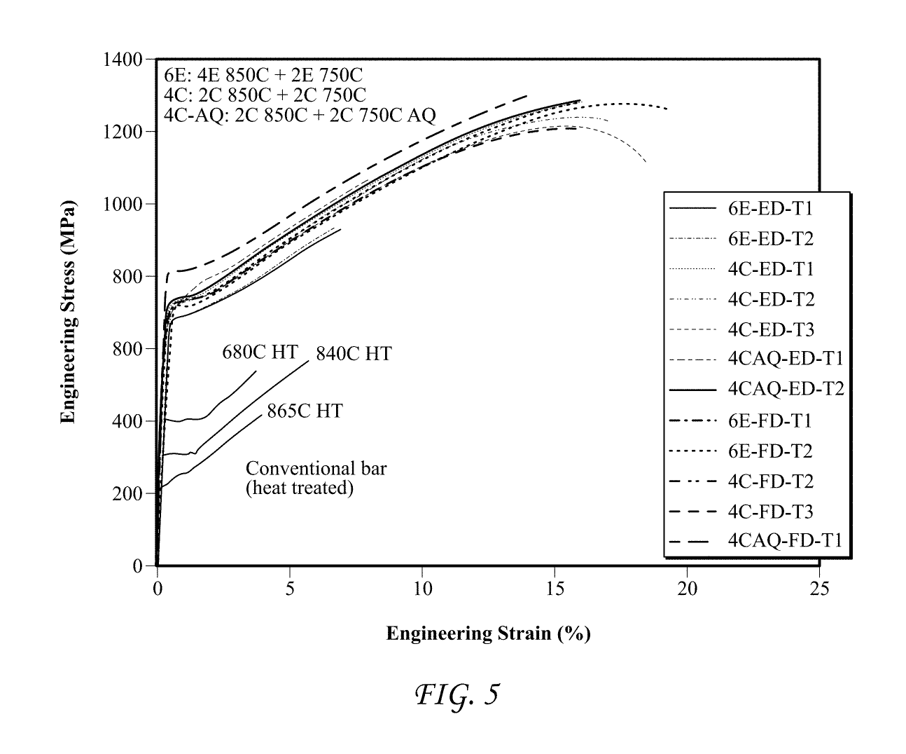

For uniaxial tension tests, flat dog-bone samples, 25 mm long and 8 mm gage length with ˜1 mm thickness were cut along the Extrusion Direction (ED) and Flow Direction (FD) using wire EDM. Two or three samples were tested in each direction to confirm repeatability. Conventional Hiperco bar samples, with 6.35 mm diameter, were also tensile tested for comparison. After ECAE, Hiperco bar exhibits high strength as shown in FIG. 5. Yield and tensile strengths of 713 +/−50 MPa (103 +/−8.5 ksi) and 1035 +/−212 MPa (150 +/−31 ksi) respectively, from a total of 20 tests are comparable to strengths found in highly cold-worked sheet, consistent with the fine grain size, i.e. Hall-Petch considerations. High strengths have not been previously achievable in bulk Hiperco. The as-ECAE material shows more than a two-fold increase in strength compared to conventional bar (YS of 200-400 MPa, 29-58 ksi). The conventional bar data are from three different heat treatments from a previous study. See D. F. Susan et al., presented at Mat. Sci. Tech. 2014, Pittsburgh, Pa., (2014).

The failure strains between 15 and 20% for the flow direction in extrusion for sample 6E and for both directions in sample 4C are among the highest reported for Hiperco in any condition. See K. Kawahara, J. Mater. Sci. 18, 3437 (1983); K. Kawahara, J. Mater. Sci. 18, 3427 (1983); K. Kawahara, J. Mater. Sci. 18, 2047 (1983); K. Kawahara, J. Mater. Sci. 18, 1709 (1983); A. Duckham et al., Acta Mat. 51, 4083 (2003); and R. S. Sundar and S. C. Deevi, Intermetallics 12, 921 (2004). Due to water quenching, it is likely that the as-ECAE material is in the disordered (bcc) or only slightly ordered state. In general, disordered material displays higher ductility than the alloy in the ordered state, but some observed differences, at this time, are attributed to the extrusion finishing temperatures. Only ECAE samples with finishing temperatures of 750° C. are displayed in FIG. 5. Extrusion 4E, processed only at 850° C., also had high strength but its ductility was lower, ˜4-6%, similar to conventional bar. The reasons for relatively low ductility in extrusion for sample 4E are not fully understood but it appears that the 850° C. finish is high enough for recovery and recrystallization (but with minimal grain growth). Higher failure strains for extrusions 6E and 4C, especially in the flow direction, suggest that a cold worked structure, not simply fine grain size, is required to sustain deformation without failure. Extrusions 6E and 4C may contain a higher dislocation density and/or a subgrain structure contributing to ductility. Overall, the higher ductility obtained with high process deformation is consistent with results for cold-worked sheet obtained by Kawahara and others. See K. Kawahara, J. Mater. Sci. 18, 3437 (1983); K. Kawahara, J. Mater. Sci. 18, 3427 (1983); K. Kawahara, J. Mater. Sci. 18, 2047 (1983); K. Kawahara, J. Mater. Sci. 18, 1709 (1983); E. P. George et al., Mater. Sci. Eng. A A329-331, 325 (2002) and D. R. Thornburg, J. Appl. Phys. 40, 1579 (1969).

Extrusion 6E shows considerable anisotropy in ductility between the flow direction and extrusion direction. The six passes of extrusion route E, therefore, produce similar anisotropy to what might be expected in sheet material (although with lower ductility in the “long” dimension of the product). Conversely, the tensile response of extrusion 4C is more isotropic and reproducible. Importantly, extrusion 4C was produced with only four passes, thereby simplifying processing as well. The reasons for differences in the degree of anisotropy among the extrusions is not known and requires further microstructural characterization. The 4C-AQ experiment attempted to form a partially or fully ordered B2 crystal structure by slowly cooling through the ordering transformation, which may impart better magnetic performance. As shown in FIG. 5, high yield and ultimate strengths are retained with air-cooling in sample 4C-AQ. Some ductility is lost, however, and some anisotropy is indicated. Even so, the failure strains of ˜7-8% and ˜14% in the ED and FD orientations, respectively, compare favorably to conventional bar material.

A few other features of interest are found in FIG. 5. First, unlike conventional bar, ECAE material does not show an upper/lower yield point (discontinuous yielding), although a slight plateau is evident just after yielding. Upper/lower yield point with 1-2% discontinuous strain and the propagation of Luders bands are typical of large-grain annealed Hiperco bar. See K. Kawahara, J. Mater. Sci. 18, 3437 (1983); D. F., presented at Mat. Sci. Tech. 2014, Pittsburgh, Pa., (2014); C. D. Pitt and R. D. Rawlings, Metal Science 17, 261 (1983); and E. Hug et al., J. Magn. Magn. Mat. 215-216, 197 (2000). Second, the material fails without appreciable necking, with the possible exception of extrusion 4C, which is also characteristic of Hiperco alloys. And third, visual examination of the fracture surface (not shown here) confirms a brittle, transgranular, quasi-cleavage fracture mode even after significant tensile straining. In addition, conventional Hiperco occasionally failed at low strain in the threaded grip region of the round tensile samples. This behavior was observed in previous studies of Hiperco bar and illustrates the notch sensitivity of this material.

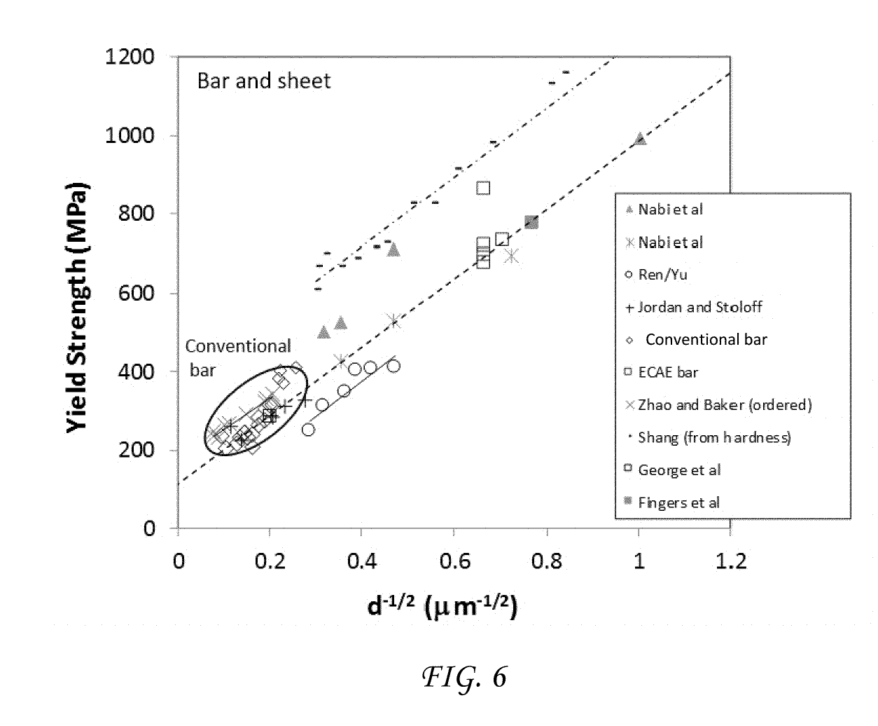

To summarize the tensile behavior, FIG. 6 shows a Hall-Petch plot of yield strength vs. (grain size)^{-1/2} according to:

σ_{y}=σ₀+kd^{-1/2},

where a_{y} is yield strength, σ₀ is intrinsic friction stress (Peierls stress), k is a constant (Hall-Petch coefficient) and d is grain size. The results for ECAE bar and a few studies on conventional bar are shown along with several studies from the literature on sheet. See C. H. Shang et al., J. Mater. Res. 15, 835 (2000); B. Nabi et al., Mater. Sci. Eng. A A592, 70 (2014); B. Nabi et al., Mater. Sci. Eng. A A578, 215 (2013); L. Ren et al., J. Mater. Sci. 36, 1451 (2001); R. H. Yu et al., J. Appl. Phys. 85, 6655 (1999); K. R. Jordan and N. S. Stoloff, Trans. Metall. Soc. AIME 245, 2027 (1969); Lie Zhao and I. Baker, Acta Met. Mat. 42, 1953 (1994); E. P. George et al., Mater. Sci. Eng. A A329-331, 325 (2002); A. Duckham et al., Acta Mat. 51, 4083 (2003); R. T. Fingers et al., J. Appl. Phys. 91, 7848 (2002); and N. S. Stoloff and I. L. Dillamore, in Ordered Alloys: Structural Applications and Physical Metallurgy, Claitors, Baton Rouge, Fla., 1970, p. 525. Conventional bar material was heat treated in the range 680-870° C. Other researchers found similar Hall-Petch slopes with some degree of scatter. See K. R. Jordan and N. S. Stoloff, Trans. Metall. Soc. AIME 245, 2027 (1969); and Lie Zhao and I. Baker, Acta Met. Mat. 42, 1953 (1994). The data from Zhao and Baker includes only their results for material in the ordered condition, slowly cooled from high temperature. FIG. 6 confirms that the ECAE bar lies in a similar strength/grain size regime as cold-worked sheet. The dashed trendline appears to be a reasonable fit to the sheet results as well as bar, with the exception of the higher strength values from Shang. Shang performed Knoop hardness measurements, from which yield strengths were estimated in a review by Sourmail and the shift to higher strengths may be due to uncertainty in the hardness to strength conversion. See T. Sourmail, Prog. Mater. Sci. 50, 816 (2005); and C. H. Shang et al., J. Mater. Res. 15, 835 (2000). With regard to order/disorder, Sourmail discussed the fact that details were not given by Shang on quenching vs. slow-cooling; the degree of order could have significant influence on the Hall-Petch behavior as well. Including all other data, the estimated Hall-Petch slope and σ₀ are 871 MPa-μm^{-1/2} and 104 MPa, respectively, as shown in Table 3. In general, for both Hiperco bar and sheet, the observed parameter ranges were Hall-Petch slope of 700-875 MPa-μm^{-1/2} and σ₀ of 100-200 MPa at room temperature. The σ₀ estimated from Knoop hardness (Shang/Sourmail) is higher than the others. Regardless, there is a notable difference between Peierls stresses reported in different studies, the reason for which is not clear.

TABLE 3
Values of σₒ and k for FeCo-based bar material.

| | Peierls Stress | k | | |
|---|---|---|---|---|
| Material | (MPa) | (MPa-mm^{1/2}) | Method | Reference |
| FeCo | 172 | 806 | compression | Zhao and |
| (ordered) | | | | Baker |
| FeCo—2V | 143 | 714 | tensile | Jordan and |
| (ordered) | | | | Stoloff |
| FeCo—2V | 26 | 848 | tensile | Ren et al. |
| (ordered) | | | | |
| Fe—27Co, | 404 | 837 | Knoop | Shang, |
| H50, H50HS | | | hardness | Sourmail |
| FeCo—2V | 104 | 871 | tensile | Present |
| (600 ppm Nb) | | | | invention |

Magnetic Testing of ECAE Hiperco and Hiperco Sheet

Magnetic testing was performed on sample 4E in both the as-ECAE and the heat-treated conditions. Magnetic B-H testing was performed according to ASTM A773. See ASTM A773/A773M-14, “Standard Test Method for Direct Current Magnetic Properties of Low Coercivity Magnetic Materials Using Hysteresis graphs”, ASTM International, West Conshohocken, Pa., 2014. Test rings with 0.90-inch outer diameter, 0.765-inch inner diameter, and thickness of 0.068 inches were EDM machined from sample 4E parallel to the extrusion plane. The tests were performed up to 500 Oe coercive force.

Hiperco sheet material was also tested, which presents some difficulties because of the thin sheet geometry. To properly test sheet material, several sheet layers were stacked together to enable winding of the Cu wire for testing. Four layers of sheet were stacked together and bonded with epoxy adhesive. The individual layers were ring shaped with outer diameter 1.36 inches and inner diameter 1.156 inches, and thickness equal to the nominal sheet thickness. For magnetic testing, the exact mass and dimensions of each layer in the stack must be carefully determined to calculate the exact amount of Hiperco in the stack (since the epoxy does not contribute to the magnetic response). After assembling the sheet stacks, the B-H testing was performed also according to ASTM A773, but with maximum coercive force of 1000 Oe.

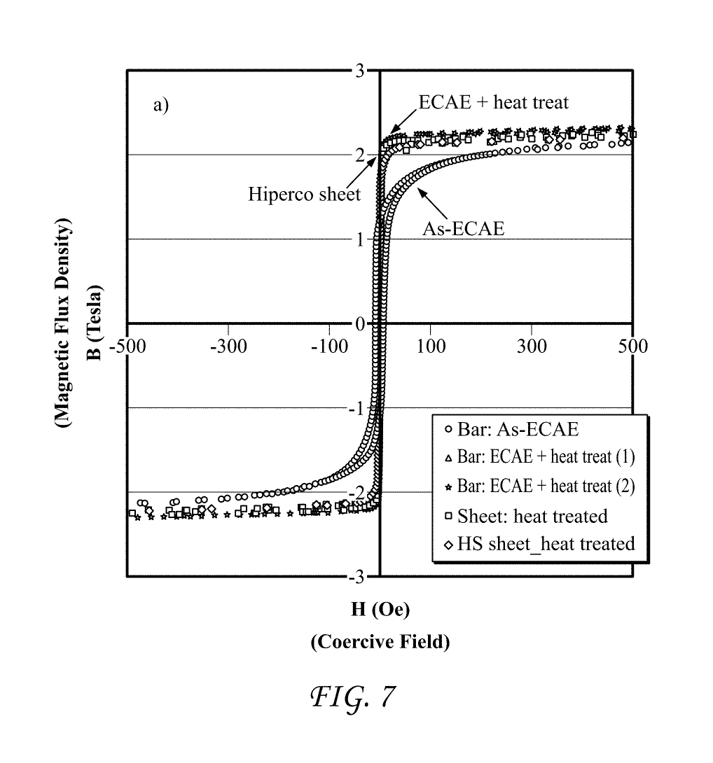

As described above, high strength and high ductility, comparable to the properties of cold-worked sheet, can be achieved under some ECAE processing conditions. Magnetic B-H loop testing (dc) was performed on ECAE samples, Hiperco 50 sheet, and Hiperco 50HS sheet using ring specimens according to ASTM A773. FIG. 7 displays the full B-H hysteresis curves from as-ECAE and heat treated (838° C., 2 hrs.) ECAE material along with the results for sheet (heat treated condition only). From this plot, it is clear that heat treatment significantly increases the magnetic saturation induction, Bₘₐₓ, of the ECAE material. After heat treatment, Bₘₐₓ of the ECAE Hiperco is slightly higher than Bₘₐₓ of sheet and the “knee” of the B-H curve is sharper for the ECAE material as well. The importance of the saturation value is that, for lower saturation values, one would need to supply more magnetomotive force, i.e. amp-turns, for a given level of solenoid output, e.g. torque.

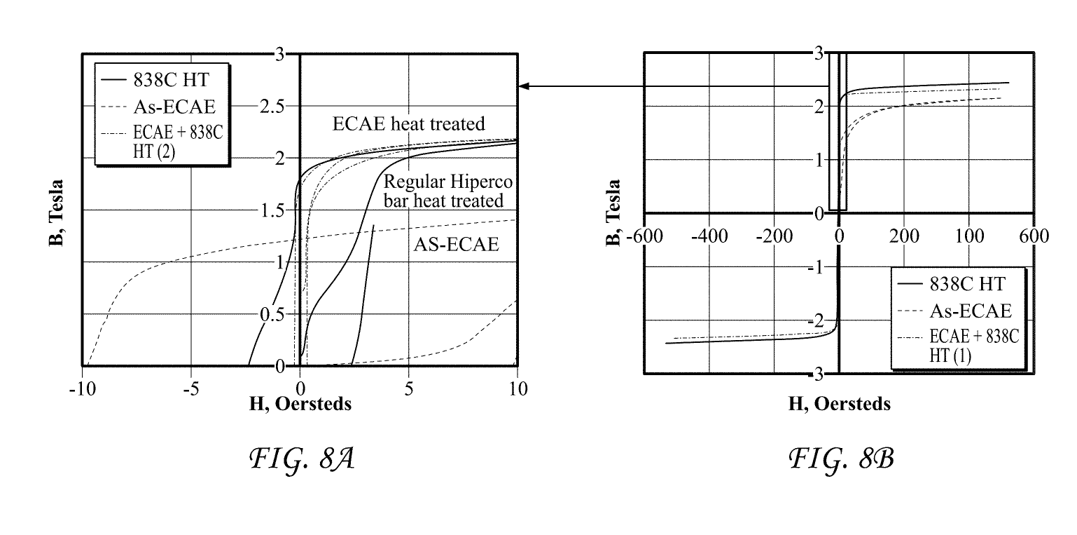

FIGS. 8A and 8B compare the B-H curves of the ECAE bar and the ECAE bar heat treated at 838° C. to those obtained from conventional Hiperco bar. The highest saturation values are found with conventional bar material heat treated at 838° C. The heat treated ECAE material also displays excellent magnetic performance. The coercivity value (“width” of the B-H loop) of 0.30 Oersteds for heat-treated ECAE material is the lowest value obtained for any of the materials tested. This indicates excellent soft magnetic behavior for ECAE material after subsequent heat treatment.

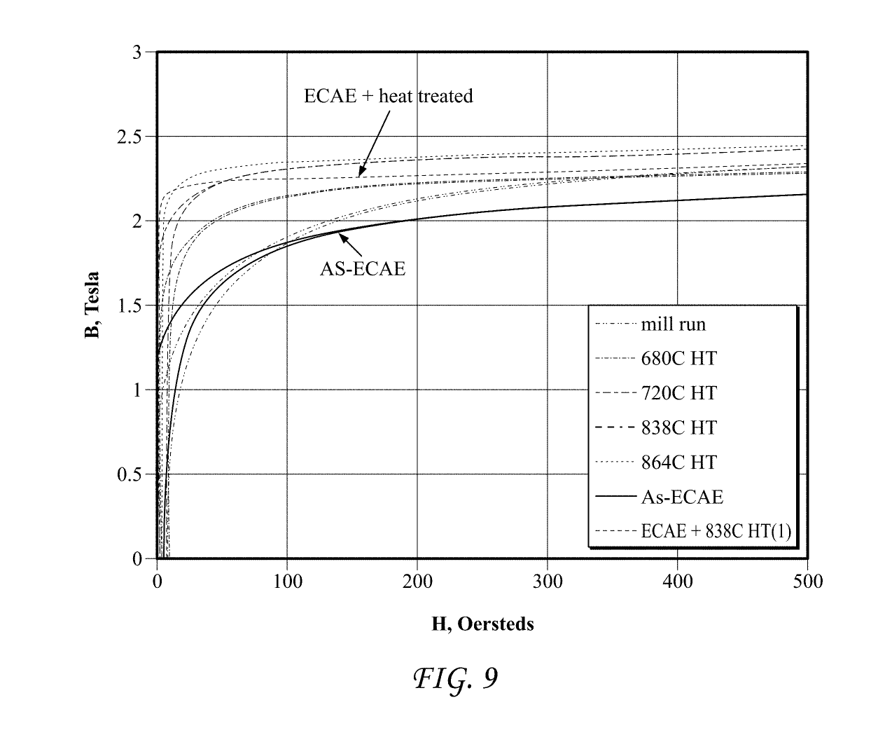

FIG. 9 shows the B-H curves for conventional “mill run” Hiperco bars with various heat treatments, compared to the as-extruded ECAE bar and the heat-treated ECAE bar. The as-extruded ECAE bar has magnetic performance similar to the “mill run” Hiperco bar. In the heat-treated condition, the ECAE bar has slightly lower magnetic saturation, slightly higher permeability, and lower coercivity than the conventional bar.

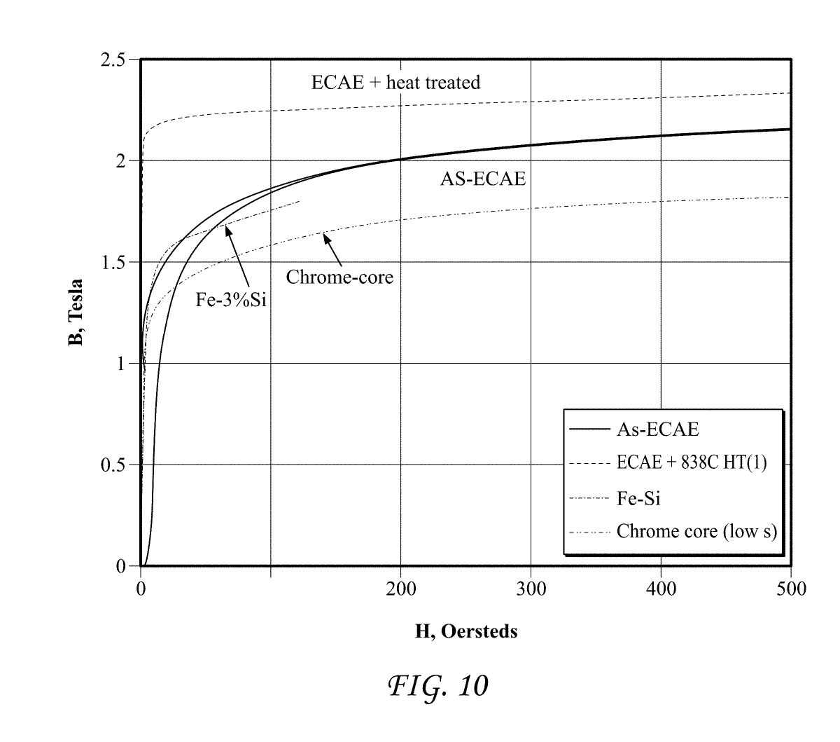

FIG. 10 compares the ECAE materials to other soft magnetic materials of interest. The saturation of Fe-3% Si is lower than the ECAE samples, but the permeability is somewhat higher than the as-ECAE Hiperco sample. The Fe-3Si alloy also exhibits poor corrosion resistance. The Chrome-Core (low sulfur) alloy is a ferritic stainless steel with much better corrosion resistance, good mechanical properties and weldability, but a low magnetic response. Table 4 summarizes the magnetic parameters for all of the materials. If designs warrant high mechanical properties due to demanding system environments, and the lower magnetic response can be tolerated, then ECAE Hiperco can be used. Lower heat treatment temperatures/shorter times can affect the tradeoff between mechanical and magnetic behavior, offering designers more appealing options. Full annealing heat treatment of ECAE material offers superior soft magnetic properties. Furthermore, simply air-cooling after ECAE can maintain magnetic performance and eliminate the need for a separate heat treatment step.

TABLE 4
Selected magnetic properties of different forms of Hiperco and other
soft magnetic alloys

| | Bₘₐₓ | Bᵣ | H_{c} | |
|---|---|---|---|---|
| Material* | (Tesla)** | (Tesla) | (Oersteds) | μₘₐₓ |
| As-ECAE Hiperco | 2.15 | 1.21 | 9.78 | 723 |
| Heat treated ECAE Hiperco | 2.34 | 1.82 | 0.30 | ~37000 |
| Mill-run Hiperco bar | 2.32 | 0.917 | 7.24 | 664 |
| Conventional bar_680C HT | 2.30 | 1.45 | 7.60 | 1308 |
| Conventional bar_720C HT | 2.46 | 1.86 | 7.47 | 1919 |
| Conventional bar_838C HT | 2.47 | 1.92 | 0.52 | 28283 |
| Conventional bar_864C HT | 2.46 | 1.58 | 0.83 | ~18000 |
| Hiperco 50 sheet_838C HT | 2.33 | 1.47 | 0.55 | 11166 |
| Hiperco 50HS sheet_838HT | 2.22 | 1.65 | 1.45 | 6373 |
| Fe—3Si (843C HT) | 2.07 | 1.15 | 0.50 | 9350 |
| Chrome-Core (low S) | 1.82 | 0.932 | 0.80 | 5874 |

*ECAE and conventional Hiperco bar from same heat of material . . . with 600 ppm Nb addition
**One Tesla equals 10,000 Gauss

The present invention has been described as severe plastic deformation of Fe—Co—V alloys. It will be understood that the above description is merely illustrative of the applications of the principles of the present invention, the scope of which is to be determined by the claims viewed in light of the specification. Other variants and modifications of the invention will be apparent to those of skill in the art.

We claim:

1. A method to produce soft magnetic alloys with good mechanical properties, comprising:
providing a bar of a Fe—Co—V alloy;
heating the bar to greater than 650° C. to increase ductility; and
subjecting the heated bar to severe plastic deformation, thereby producing a deformed alloy having a fine grain size and a uniform grain size from center to edge of the bar.

2. The method of claim 1, wherein the severe plastic deformation comprises equal channel angular extrusion, also known as equal channel angular pressing.

3. The method of claim 1, wherein the severe plastic deformation comprises accumulated roll bonding, high pressure torsion, or mechanical alloying.

4. The method of claim 1, wherein the severe plastic deformation produces strains of greater than 100%.

5. The method of claim 1, wherein the Fe—Co—V alloy comprises 47.50 to 49.50 wt % cobalt, 1.75 to 2.10 wt % vanadium, with balance iron.

6. The method of claim 1, wherein the fine grain size produced is less than 3 microns.

7. The method of claim 1, wherein the deformed alloy has a yield strength greater than 600 MPa.

8. The method of claim 1, wherein the deformed alloy has an ultimate tensile strength of greater than 900 MPa.

9. The method of claim 1, wherein the deformed alloy has a ductility of greater than 8% elongation.

10. The method of claim 1, further comprising heat treating the deformed alloy to optimize the tradeoff between mechanical properties and magnetic behavior.

11. The method of claim 10, wherein the heat treating comprises heating the deformed alloy to greater than 800° C.

12. The method of claim 10, wherein the magnetic response after heat treating has a coercivity value of less than 0.7 Oersteds.

13. The method of claim 1, wherein the Fe—Co—V alloy further comprises Nb.

14. The method of claim 13, wherein the Fe—Co—V alloy comprises less than 0.30 wt % Nb.
